(19) United States
(12) Patent Application Publication
(10) Pub. No.: US 2008/0302592 A1
(43) Pub. Date: Dec. 11, 2008

(54) Connection Assembly for a Truck

(75) Inventor: Goran Levin, Hisings-Karra (SE)

Correspondence Address: WRB-IP LLP, 1217 KING STREET, ALEXANDRIA, VA, 22314, US

(73) Assignee: CPAC SYSTEMS AB, Goteborg (SE)

(21) Appl. No.: 12/159,413

(22) PCT Filed: Jan. 11, 2007
(86) PCT No.: PCT/SE07/00014

§ 371 Date: Jun. 27, 2008

(30) Foreign Application Priority Data
Jan. 17, 2006 (SE) 0600105-1

(51) Int. Cl. B62D 33/067

(52) U.S. Cl. 180/328

(57) ABSTRACT

A connection assembly for a truck is provided, the truck including a chassis accommodating one or more components, a pivotable driver's cabin, wherein an arrangement associated with the components on the chassis is arranged, wherein the cabin is mounted to the chassis by a pivotable mounting arrangement; and a flexible connection arrangement linking the components of the chassis and the associated arrangement arranged in the cabin, wherein the pivotable mounting arrangement includes a linkage arm having a rear end which is pivotably mounted to a chassis bracket and a front end where the cabin is pivotably mounted; and the flexible connection arrangement is mounted to the linkage arm. The required space around the pivoting mounting point can be significantly reduced, as it is realised that by using a frontal pivot point in the design of the pivotable mounting arrangement, the flexible connection arrangement, i.e. the bundle of media (cables and tubes) can be fixed to the linkage arm of the mounting arrangement.

### BACKGROUND AND SUMMARY

The present invention relates to a connection assembly for a truck, said truck comprising a chassis accommodating one or more components, a pivotable driver's cabin, wherein means associated with the components on the chassis are arranged, wherein the cabin is mounted to the chassis by a pivotable mounting means; and flexible connection means linking the components of the chassis and the associated means arranged in the cabin.

In a truck or semi-tractor, it is common to design the vehicle with a driver cabin which may be tipped forward for gaining access to the drive system, i.e. the engine and gearbox. From DE 42 43 184 A1 is known an assembly holding cooling line tubes and other connecting lines connecting equipment mounted on the pivotable driver cabin to the chassis to equipment mounted on the chassis. These connecting may be tubes for cooling water connecting the water cooler or coolers on the front of the driver cabin and the water-cooled engine mounted in the chassis and electrical wiring and other connecting cables connecting the driver's controls to the relevant sensors, lamps, etc on the chassis of the vehicle.

Other devices of similar kind are known from e.g. DE 103 16 915 A1 and DE 27 11 122 A1.

In these known assemblies, these connecting lines are provided in excessive length and predetermined bends so that the pivoting of the driver's cabin does not cause any of these connections to fail. These connection lines transferring communication signals, fluids, etc. are often referred to as media, and any damage to these may have fatal consequences, and therefore it is vital that they are mounted in the pivot assembly of the cabin and the chassis in such a way that they are allowed to flex and bend in a predetermined manner.

Because of these extra lengths, the flexible connection means (i.e. the bundle of cables, tubes, etc.) must have sufficient space in order to allow the bending of these connections when the cabin is in the driving position.

The development of trucks demands ever more control and surveillance systems for the driver. This means that more cables and wiring is needed, increasing the size of the bundles of the media connection assembly between the cabin and the chassis. However, the space available around the pivotable cabin mounting means and the media connection assembly is constricted. On this background it is desirable to provide a less space consuming solution to the media connection assembly.

According to an aspect of the present invention, a connection assembly for a truck of the initially mentioned kind, wherein the pivotable mounting means comprises a linkage arm having a first end which is pivotably mounted to a chassis bracket and a second end where the cabin is pivotably mounted, and that said flexible connection means are mounted to the linkage arm.

By an aspect of the invention, the required space around the pivoting mounting point is significantly reduced, as it is realised that by using e.g. a frontal pivot point in the design of the pivotable mounting means, the flexible connection means, i.e. the bundle of media (cables and tubes) can be fixed to the linkage arm of the mounting means. The pivotable mounting means comprises a linkage arm with one end pivotably mounted to a chassis bracket and the other end connected to dampening means. Hereby, the cabin is pivotably mounted as well as mounted with a spring dampened support, so that the cabin is dampened and vibrations from the chassis are absorbed. This means that when the cabin is tipped forward, the flexible connection means bend in front of the linkage arm and when the truck is subjected to uneven surfaces during driving, the cabin may move by pivoting around the rear linkage point, whereby the flexible connection will bend at its portion behind the mounting bracket. The bending of the flexible connection in the mounting region due to relative movements between the cabin and the chassis does not require any flexibility in lengths by a connection assembly according to an aspect of the invention. This means that excessive lengths of the connections are obsolete. This in turn means that less space is required and a more predictable flexing pattern of the connection means may be achieved. This may result in a more reliable flexible connection of the components in the chassis and the associated equipment in the cabin.

Besides providing for a compact arrangement of the media connections by a connection assembly according to an aspect of the invention, the assembly according to an aspect of the invention also provides an improved protection in the event of a crash since the medias may be protected inside the chassis members and may also be fastened to the cabin structure so that the cables and hoses are less likely to be damaged in the event of a frontal collision.

In a first embodiment of an aspect of the invention, the first end of the linkage arm is the a rear end, which is pivotably mounted to a chassis bracket and the second end is the front end, where said arm may be connected to dampening means and where the cabin is pivotably mounted. However, it is realised that other pivotal arrangements may also be provided with a connection assembly according to an aspect of the invention.

The connection means preferably include water cooling hoses for connecting one or more water coolers in the cabin to a water cooled engine mounted in the chassis. Moreover, the connection means may further include fluid hoses, pneumatic hoses, electric wires and cables as well as activation means for allowing the driver to monitor various vehicle conditions and operating the vehicle from the cabin. Since the cabin is typically mounted at two (or more) mounting points, individual media connections according to an aspect of the invention may be provided at each of the mounting points.

The connection means are preferably accommodated inside the cavity of a longitudinal chassis member and exit said cavity behind the chassis bracket of the pivotable mounting means. By accommodating the media inside the chassis member, the connection members are well protected. At least at the point of exiting the cavity of the chassis member, the connection may be fastened to the chassis member. Hereby, the connection may be stress relieved in the pivoting mounting area.

Preferably, the connection means are mounted to the front and rear ends of the linkage arm. Hereby, it is ensured that the connection means following the movement of the suspension mounting as close as possible and by fixing the connection means to the linkage arm at its front and rear ends, the bending of the connection may be more precise.

### BRIEF DESCRIPTION OF THE DRAWINGS

In the following, the invention is described in more detail with reference to the accompanying drawings, in which:

FIG. 1 is a schematic side view of a truck with a connection assembly according to a first embodiment of the invention;

FIG. 2 is a schematic detailed view of the assembly according to a first embodiment of the invention;

FIG. 3 is a principal cross sectional front view of a linkage arm of the connection assembly; and

FIG. 4 is a schematic detailed view of a second embodiment of the invention.

### DETAILED DESCRIPTION

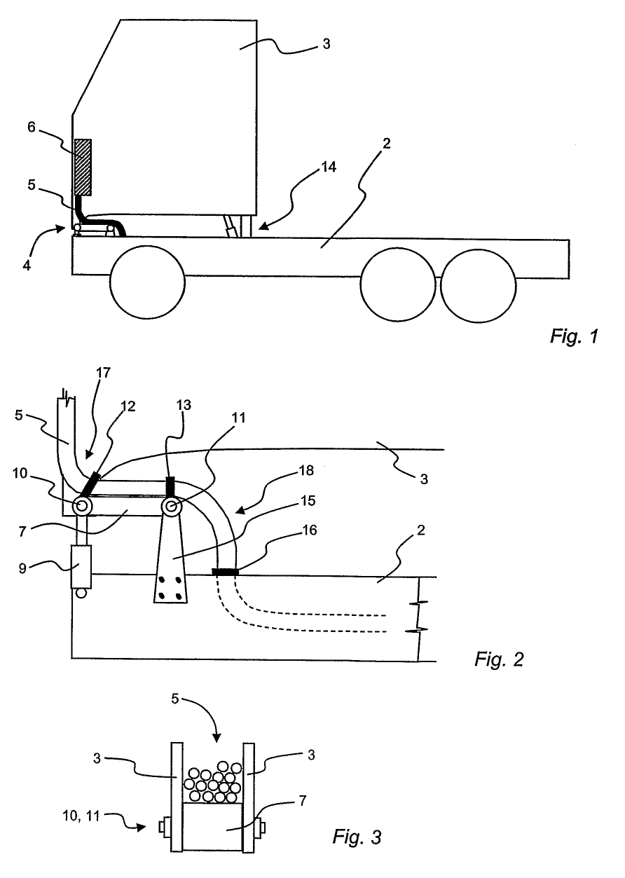

With reference to FIG. 1, a truck according to a first embodiment of the invention is shown with a chassis 2 and a driver's cabin 3 which is pivotably mounted to the chassis 2 at the mounting means 4 in the front. The cabin 3 can be tipped to gain access to the engine of the truck which is mounted in the chassis 2 under the cabin 3. The cabin 3 is mounted to the chassis 2 in such a way that the cabin 3 may be tipped forward and during driving, the cabin 3 is suspended to ensure the comfort of the driver. The cabin 3 is mounted at the front at the pivotable mounting means 4 and at the rear of the cabin 3 at detachable mounting and dampening means 14.

In the cabin 3 a number of media 6 are accommodated. These media 6 are connected to associated components mounted in the chassis (not shown) by a flexible connection 5. These media 6 may include one or more water coolers, oil coolers, electrical gauges, etc. The connections 5 accordingly comprise a bundle of water, oil and/or other flexible fluid hoses, electrical cables and wires. The connection 5 is arranged around the cabin tip mounting means 4 in such a way that the connections 5 are not damaged when the cabin 3 is tipped forward. In FIG. 2, the tip mounting assembly between the cabin 3 and the chassis 2 is shown in more detail.

The mounting means 4 include a mounting bracket 15 on the chassis 2. A linkage arm 7 is pivotably mounted at the rear pivot point 11 at the rear end of the linkage arm 7 to the mounting bracket 15. The linkage arm 7 is pivotably mounted at the front pivot point 10 which may be connected to a telescopic dampening cylinder 9 or similar dampening means at the front end of the linkage arm 7. The cabin 3 is pivoting around the forward pivot point 10 at the cabin leg provided at the bottom of the cabin 3. The cabin 3 can move up and down relative to the chassis 2 by an angular displacement of the linkage arm 7 relative to the rear pivot point 11. The cabin 3 can be tipped forward by releasing the rear cabin end mounting 14 (see FIG. 1).

The connection tubes, hoses, cables and wires may be bundled together and this connection assembly 5 is secured to the linkage arm 7, e.g. by fixation brackets 12, 13 at the two pivot ends 10, 11 of the linkage arm 7. In front of the front fixation bracket 12, the connections 5 are provided with a first bend 17 bending upwards and connecting the relevant components in the cabin 3. Behind the rear fixation bracket 13 the connections is provided with a second bend 18 which is directed downwards and the connections 5 then extend into the cavity of the chassis 2 to connect with the relevant components in the chassis 2. The first bend 17 is straightened when the cabin 3 is tipped forward. Both the first bend 17 and the second bend 18 are being flexed somewhat during driving as movements in the chassis are dampened as they are transferred via the mounting means 4, 14 to the cabin 3. However, unlike prior art solutions no additional space is required in front and behind the linkage arm mounting system, since the functions of the front and rear pivot points have been reversed in the invention and that the flexible connections 5 are secured to the linkage arm 7 so that only bending movements of the connections 5 that are required during the tipping of or dampening movements of the cabin 3.

Typically, the chassis include I- or U-shaped longitudinal girders and the electrical cables, fluid tubes, etc. can preferably be accommodated in the cavities thereof whereby these connections 5 are well protected. Preferably, the connections 5 are fixed in the entry region where the connections 5 enter the chassis 2, e.g. by a fastening collar 16. Hereby, the connections 5 are stress-less and tension-free in the pivotable mounting means.

As shown in FIG. 3, the connections 5 may be accommodated on the linkage arm 7 and protected by the cabin legs of the cabin 3. Hereby, the connections may be protected against damage in the event of a crash also during the connection path between the chassis and the cabin.

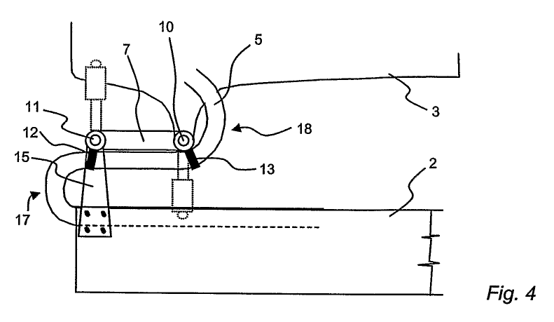

With reference to FIG. 4, a second embodiment of the invention is schematically shown. The connection tubes, hoses, cables and wires may be bundled together and this connection assembly 5 is secured to the linkage arm 7, e.g. by fixation brackets 12, 13 at the two pivot ends 10, 11 of the linkage arm 7. In front of the front fixation bracket 12, the connections 5 are provided with a first bend 17 bending upwards at about 180 degrees and the connections 5 then extend into the cavity of the chassis 2 to connect with the relevant components in the chassis 2. Behind the rear fixation bracket 13 the connections is provided with a second bend 18 which is directed upwards and connecting the relevant components in the cabin 3.

The first bend 17 is to some extend straightened when the cabin 3 is tipped forward. Both the first bend 17 and the second bend 18 may be flexed somewhat during driving as movements in the chassis are dampened as they are transferred via the mounting means 4, 14 to the cabin 3. However, unlike prior art solutions no additional space is required in front and behind the linkage arm mounting system, since the connections 5 are secured to the linkage arm 7 so that only bending movements of the connections 5 that are required during the tipping of or dampening movements of the cabin 3.

Above, the invention is described with reference to some preferred embodiments of the invention. However, it is realised that other embodiments may be provided without departing from the scope of the invention as it is defined in the accompanying claims. For instance, the first and second bends 17, 18 may be provided in any direction without departing from the invention, and by the invention it is realised that the bends may be provided in the sideways direction, just as up- or downwards as described in the example of the drawings.

1. A connection assembly for a track, the track comprising:
a chassis accommodating one or more components,
a pivotable driver's cabin, wherein means associated with the components on the chassis are arranged, wherein the cabin is mounted to the chassis by a pivotable mounting means; and
connection means linking the components of the chassis and the associated means arranged in the cabin,
wherein
the pivotable mounting means comprises a linkage arm having a first end which is pivotably mounted to a chassis bracket and a second end where the cabin is pivotably mounted; and the flexible connection means are mounted to the linkage arm.

2. An assembly according to claim 1, wherein the connection means includes water cooling hoses for connecting one or more water coolers in the cabin to a water cooled engine mounted in the chassis.

3. An assembly according to claim 2, wherein the connection means includes at least one of hydraulic hoses, pneumatic hoses and other fluid hoses, electric wires and power supply cables, and activation means for allowing the driver to monitor various vehicle conditions and operating the vehicle from the cabin.

4. An assembly according to claim 1, wherein the connection means is accommodated inside the cavity of a longitudinal chassis member and exit the cavity behind the chassis bracket of the pivotable mounting means.

5. An assembly according to claim 1, wherein the connection means is mounted to the first and second ends of the linkage arm.

6. An assembly according to claim 1, wherein the first end of the linkage arm is the a rear end, which is pivotably mounted to a chassis bracket and the second end is the front end, where the arm is connected to dampening means and where the cabin is pivotably mounted.

7. An assembly according to claim 1, wherein the connection means is flexible.
